(19) United States
(12) Patent Application Publication
(10) Pub. No.: US 2023/0314276 A1
(43) Pub. Date: Oct. 5, 2023

(54) METHODS OF CATEGORIZING SINGLE MODE OPTICAL FIBERS

(71) Applicant: CORNING INCORPORATED, CORNING, NY (US)

(72) Inventors: Xin Chen, Painted Post, NY (US); Kangmei Li, San Jose, CA (US); Ming-Jun Li, Horseheads, NY (US); Snigdharaj Kumar Mishra, Wilmington, NC (US); Simit Mayank Patel, Greensboro, NC (US)

(21) Appl. No.: 18/128,655

(22) Filed: Mar. 30, 2023

Related U.S. Application Data
(60) Provisional application No. 63/326,432, filed on Apr. 1, 2022.

(51) Int. Cl. G01M 11/00; H04B 10/07

(52) U.S. Cl. CPC G01M 11/30; H04B 10/07

(57) ABSTRACT

A method of categorizing single mode optical fibers, the method including determining one or more fiber properties of an optical fiber, the optical fiber being a single mode optical fiber at an operating wavelength of about 1310 nm. The method further including calculating a peak bandwidth wavelength of the optical fiber based on the one or more fiber properties, comparing the calculated peak bandwidth wavelength with a target peak bandwidth wavelength and based on the comparison, determining if the optical fiber meets a target modal bandwidth.

This application claims the benefit of priority under 35 U.S.C § 120 of U.S. Provisional Application Ser. No. 63/326,432 filed on Apr. 1, 2022, the content of which is relied upon and incorporated herein by reference in its entirety.

### FIELD

The present disclosure generally relates to methods of categorizing single mode optical fibers, and more particularly relates to methods of categorizing single mode optical fibers to determine if the fibers meet a predetermined target modal bandwidth.

### BACKGROUND

Standard single mode optical fibers are the preferred type of optical fibers for use in hyperscale data centers because they have a higher bandwidth than multimode fibers. Having a higher bandwidth provides such benefits as higher data rate and longer system reach in the centers. However, hyperscale data centers include short optical links (in the range from 1 meter to 100 meters), for which multimode fibers are preferred. Multimode fibers are especially preferred when multimode light sources are utilized, such as vertical cavity surface emitting lasers (VCSELs).

Even though multimode fibers are preferred for the relatively shorter optical links in hyperscale data centers, operators still prefer to use standard single mode optical fibers for both the relatively long and short optical links in order to simplify fiber cable management. But this simplified cable management approach comes at the expense of optical transmission performance. Single mode fibers do not perform as well with short optical links that use multimode light sources. Also, it is difficult to efficiently couple the light from a multimode VCSEL into standard single mode optical fibers due to mismatched optical properties.

The fiber cable management issues can be avoided if low-cost optical transmission can be performed using single mode optical fibers for the short optical links. VCSELs that emit single mode (or few mode) light offer the promise of better system performance than multimode VCSELs. The single mode VCSELs are made using a platform and process similar to that used to form multimode VCSELs so that their respective costs are about the same. On the other hand, the lower numerical aperture (NA) and smaller spot size of the light emission from single mode VCSELs make them more suitable for launching into smaller core optical fibers (such as single mode optical fibers).

### SUMMARY

Both single mode and multimode VCSELs typically operate at 850 nm for optical fiber data transmission, but the VCSELs can be made to operate within other wavelength ranges. At a wavelength of about 850 nm, a standard single mode optical fiber designed for single mode operation at wavelengths above 1300 nm can support a few modes. Thus, a single mode VCSEL can couple to such a fiber with relatively low insertion loss. Other laser sources such as few-mode VCSEL or multimode VCSEL can also couple light into the standard single mode fiber with proper coupling optics. But the single mode optical fiber must have a modal bandwidth optimized for use at 850 nm in order to be suitable for high data rate transmission. Therefore, single mode optical fibers with a modal bandwidth optimized for use at a wavelength of about 850 nm are needed.

Embodiments of the present disclosure categorize single mode optical fibers to determine if the fibers meet a target modal bandwidth. In some embodiments, the target modal bandwidth is 850 nm and the fibers are categorized based upon whether they are suitable for high data rate transmission while also being suitable to couple to a single mode VCSEL. However, the methods disclosed herein may also be used to categorize single mode optical fibers to determine if the fibers meet other target modal bandwidths than 850 nm.

Methods are disclosed herein that categorize single mode optical fibers to obtain fibers with a target modal bandwidth. In some embodiments, the target modal bandwidth is a high modal bandwidth. In order to categorize the fibers, peak bandwidth wavelength is used as the criteria to determine if the fibers meet the target bandwidth threshold. Thus, the modal bandwidth of the fibers is not measured directly. Instead, the modal bandwidth of the fibers is determined based upon a calculated peak bandwidth wavelength. If the peak bandwidth wavelength of an optical fiber is close to the operating wavelength of the VCSEL (for example, if the peak bandwidth wavelength is about 850 nm and the VCSEL operates at about 850 nm), the modal bandwidth of the optical fiber will be very high at the operating wavelength. On the other hand, if the peak bandwidth wavelength of the optical fiber is far away from the operating wavelength of the VCSEL, the modal bandwidth of the optical fiber will be low at the operating wavelength.

The inventors of the present disclosure discovered the unique relationships between one or more fiber properties and the peak wavelength of an optical fiber and how those relationships relate to the peak bandwidth of the fiber. Thus, the embodiments of the present disclosure utilize fiber properties already calculated or obtained during the manufacturing process of an optical fiber to determine how they affect peak bandwidth wavelength. The peak wavelength is then used to determine if the optical fiber meets a target modal bandwidth. Because the embodiments of the present disclosure utilize properties already calculated or obtained during the manufacturing process, the target modal bandwidth of the optical fiber can be easily calculated without the addition of extra data gathering steps. One can easily determine if the fibers meet a high bandwidth requirement or not.

In some embodiments, the factors utilized include (i) radius A of a centerline dip, (ii) depth B of a centerline dip, (iii) alpha value, (iv) core radius, (v) mode field diameter at 1310 nm, and (vi) zero dispersion wavelength.

Aspects of the disclosure are directed to a method of categorizing single mode optical fibers, the method comprising determining one or more fiber properties of an optical fiber, the optical fiber being a single mode optical fiber at an operating wavelength of about 1310 nm. The method further comprising calculating a peak bandwidth wavelength of the optical fiber based on the one or more fiber properties, comparing the calculated peak bandwidth wavelength with a target peak bandwidth wavelength, and based on the comparison, determining if the optical fiber meets a target modal bandwidth.

Aspects of the disclosure are directed to a method of categorizing single mode optical fibers, the method comprising determining a fiber property of an optical fiber precursor. The optical fiber precursor being a precursor to a single mode optical fiber at an operating wavelength of about 1310 nm, a core portion of the optical fiber precursor having a centerline dip, and the fiber property being a depth of the centerline dip of the core portion. The method further comprising comparing the fiber property with a centerline dip threshold and based on the comparison, determining if the optical fiber precursor has a high probability of forming an optical fiber with a high modal bandwidth.

Aspects of the disclosure are directed to a method of categorizing single mode optical fibers, the method comprising determining a relationship between peak bandwidth wavelength in a drawn optical fiber and one or more fiber properties, the optical fiber being a single mode optical fiber at about 1310 nm. The one or more fiber properties including at least one of: (i) radius A of a centerline dip in the optical fiber, (ii) depth B of the centerline dip in the optical fiber, (iii) depth B of the centerline dip in a precursor to the optical fiber, (iv) alpha value in the optical fiber, (v) core radius in the optical fiber, (vi) mode field diameter at 1310 nm in the optical fiber, and (vii) zero dispersion wavelength in the optical fiber. The method further comprising based on the relationship, determining if the optical fiber meets a target modal bandwidth.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description explain the principles and operation of the various embodiments.

### BRIEF DESCRIPTION OF THE DRAWINGS

FIG. 1A shows exemplary refractive index profile plots of relative refractive index 4% (r) versus the radial coordinate r (microns) for three optical fiber profiles;

FIG. 1B shows exemplary modal bandwidth plots of modal bandwidth (GHz·km) versus wavelength (microns) for the three optical fiber profiles of FIG. 1A;

FIG. 2 depicts an exemplary process of categorizing optical fibers and precursors thereof according to the embodiments disclosed herein;

FIG. 3 shows an exemplary modal bandwidth plot of modal bandwidth (GHz·km) versus alpha profile at a wavelength of 850 nm;

FIG. 4 shows an exemplary refractive index profile plot of relative refractive index 4% (r) versus the normalized radius for an exemplary optical fiber precursor that comprises a centerline dip;

FIG. 5 depicts an exemplary process of categorizing optical fiber precursors according to the embodiments disclosed herein;

FIG. 6 depicts an exemplary process of categorizing optical fibers according to the embodiments disclosed herein;

FIG. 7A is a plot depicting the relationship between mode field diameter (microns) and peak wavelength (nm) in single mode optical fibers; and

FIG. 7B is a plot depicting the relationship between zero dispersion wavelength (nm) and peak wavelength (nm) in single mode optical fibers.

### DETAILED DESCRIPTION

Reference is made in detail to example embodiments illustrated in the accompanying drawings. Whenever possible, the same reference numerals are used throughout the drawings to refer to the same or like parts.

The claims as set forth below are incorporated into and constitute part of this Detailed Description.

The limits on any ranges cited herein are inclusive and thus lie within the range, unless otherwise specified.

The terms “comprising,” and “comprises,” e.g., “A comprises B,” is intended to include as a special case the concept of “consisting,” as in “A consists of B.”

The symbol “μm” is used as shorthand for “micron,” which is a micrometer, i.e., 1×10⁻⁶ meter.

The symbol “nm” is used as shorthand for “nanometer,” which is 1×10−9 meter.

The coordinate r is a radial coordinate, where r=0 corresponds to the centerline of the fiber.

The term “fiber” as used herein is shorthand for optical fiber.

The term “single mode” when referring to an optical fiber means herein that the optical fiber supports a single linear polarization (LP) mode at an operating wavelength equal to or greater than the cut-off wavelength.

A standard single mode optical fiber referred to herein and such as mentioned above has optical properties according to the G.652 industry standards known in the art and as set forth by Telecommunication Industry Association (TIA). A standard single mode optical fiber has a relatively small core of about 9 microns in diameter and a numerical aperture (NA) of about 0.12. A standard single mode fiber is designed to have a cable cut-off wavelength below (i.e., less than) 1260 nm so the fiber supports only one mode at 1310 nm and supports a few modes at 850 nm. Typically, a standard single mode fiber has a step index profile associated with a high alpha parameter (e.g., α≥10). The step index profile is simple, but the bandwidth at 850 nm is low. Consequently, a standard single mode fiber with a step index is not suitable for few mode or bi-mode transmission at 850 nm due to its low modal bandwidth at a wavelength of about 850 nm.

The term “few mode” when referring to an optical fiber herein means that the optical fiber supports two or three linear polarization (LP) modes, and typically refers to a single mode fiber operating below the cut-off wavelength (defined below). A given optical fiber can be both single moded and few moded since single mode and few mode operation is determined by the wavelength of light used.

The term “bi-mode” when referring to an optical fiber means a special case of a few mode optical fiber that supports only two modes, e.g., LP₀₁ and LP₁₁ modes.

“Refractive index” refers to the refractive index at a wavelength of 1550 nm, unless otherwise specified.

“Relative refractive index,” as used herein, is defined as:

$${Δ}_{i} ( {r}_{i} ) \% = 100 \frac{( {n}_{i}^{2} - {n}_{ref}^{2} )}{2 {n}_{i}^{2}}$$

where nᵢ is the refractive index at radial position rᵢ in the glass fiber, unless otherwise specified, and n_{ref} is the refractive index of pure silica glass, unless otherwise specified. Accordingly, as used herein, the relative refractive index percent is relative to pure silica glass, which has a value of 1.444 at a wavelength of 1550 nm. As used herein, the relative refractive index is represented by Δ (or “delta”) or Δ% (or “delta %) and its values are given in units of “%”, unless otherwise specified. Relative refractive index may also be expressed as Δ(r) or Δ(r) %.

In cases where the refractive index of a region is less than the reference index net, the relative index percent is negative and is referred to as having a depressed region or depressed-index (also referred to as a “trench”), and the minimum relative refractive index is calculated at the point at which the relative index is most negative unless otherwise specified. In cases where the refractive index of a region is greater than the reference index n_{cl}, the relative index percent is positive, and the region can be said to be raised or to have a positive index.

The refractive index of an optical fiber profile may be measured using commercially available devices, such as the IFA-100 Fiber Index Profiler (Interfiber Analysis LLC, Sharon, MA USA) or the S14 Refractive Index Profiler (Photon Kinetics, Inc., Beaverton, OR USA). These devices measure the refractive index relative to a measurement reference index, n(r)-nₘₑₐₛ, where the measurement reference index nₘₑₐₛ is typically a calibrated index matching oil or pure silica glass. The measurement wavelength may be 632.5 nm, 654 nm, 677.2 nm, 654 nm, 702.3 nm, 729.6 nm, 759.2 nm, 791.3 nm, 826.3 nm, 864.1 nm, 905.2 nm, 949.6 nm, 997.7 nm, 1050 nm, or any wavelength therebetween. The absolute refractive index n(r) is then used to calculate the relative refractive index as defined in the equation above.

The term “α-profile” or “alpha profile” refers to a relative refractive index profile Δ(r) that has the functional form defined in:

$$Δ ( r ) = Δ ( {r}_{0} ) [ 1 - {[ \frac{\vert r - {r}_{0} \vert}{( {r}_{z} - {r}_{0} )} ]}^{α} ]$$

where r₀ is the radial position at which Δ(r) is maximum, Δ(r₀)>0, r₂>r₀ is the radial position at which Δ(r) decreases to its minimum value, and r is in the range rᵢ≤r≤r_{f}, where rᵢ is the initial radial position of the α-profile, r_{f} is the final radial position of the α-profile, and a is a real number. Δ(r₀) for an α-profile may be referred to herein as Δₘₐₓ or, when referring to a specific region i of the fiber, as Δᵢₘₐₓ. When the relative refractive index profile of the fiber core region is described by an α-profile with r₀ occurring at the centerline (r=0), r_{z} corresponding to the outer radius rᵢ of the core region, and Δ₁(r₁)=0, the above equation simplifies to:

$${Δ}_{1} ( r ) = {Δ}_{1 max} [ 1 - {[ \frac{r}{{r}_{1}} ]}^{α} ]$$

The “mode field diameter” or “MFD” of an optical fiber is determined using the Peterman II method, which is the current international standard measurement technique for measuring the mode field diameter of an optical fiber. The mode field diameter is given by:

$$MFD = 2 w$$

$$w = {[ 2 \frac{{\int }_{0}^{∞} {( f ( r ) )}^{2} rdr}{{\int }_{0}^{∞} {( \frac{df ( r )}{dr} )}^{2} rdr} ]}^{1 / 2}$$

where ƒ(r) is the transverse component of the electric field distribution of the guided optical signal and r is radial position in the fiber. The mode field diameter depends on the wavelength of the optical signal and is reported herein at selected wavelengths as indicated below.

The term “bandwidth” is denoted BW and as the term is used herein is the modal bandwidth. For purposes of this disclosure, the modal bandwidth is the capacity of an optical fiber measured in MHz·km or GHz·km. For the bandwidth measurement, the two propagating modes in a fiber (e.g., LP₀₁ and LP₁₁) are excited with comparable weights, which is essentially the overfilled bandwidth. The worst case bandwidth of the fiber is defined by the modal delay T between the two propagating modes when the two modes are equally excited and is related to the modal delay T in one embodiment via the equation:

BW(τ)=b·(1/τ)=(⅓)·(1/τ)

and is hereinafter referred to as the “bandwidth equation” where b is a constant coefficient. In some other embodiments, the coefficient b in the bandwidth equation can be larger than ⅓. The values for the bandwidths BW referred to herein are based on the above equation with the coefficient b of (⅓) unless otherwise noted. A value of b=⅓ provides conservative or “worst case” value for calculating the bandwidth from the modal delay.

The “target modal bandwidth” refers to a select bandwidth associated with a wavelength of interest, as discussed further below.

The zero dispersion wavelength is the wavelength where material dispersion and waveguide dispersion cancel each other. In silica-based optical fibers, the zero dispersion wavelength is about 1300 nm, e.g., between 1300 and 1324 nm, depending on the dopants used to form the optical fiber.

The operating wavelength is denoted by λ and is a wavelength at which the optical fiber can operate while supporting (guiding) a single mode, two modes, or a few modes.

The term “peak wavelength” or “peak bandwidth wavelength” means a wavelength of light that maximizes the bandwidth of the fiber. Techniques for measuring the peak wavelength of a fiber based on multi-wavelength measurement techniques and differential mode delay techniques are known in the art and are described for example in U.S. Pat. No. 10,131,566, which is incorporated by reference herein.

The term “target peak wavelength” or “target peak bandwidth wavelength” is denoted by λ_{T} and refers to a select wavelength, as discussed further below.

The cut-off wavelength is denoted λ_{c} and is the minimum wavelength at which the optical fiber will support only one propagating mode. For wavelengths below (less than) the cut-off wavelength λ_{c}, multimode (or few mode or bimodal) transmission may occur, and an additional source of modal dispersion may arise to limit the fiber's bandwidth. Thus, the single mode operating wavelength λ, has a lower limit of λ_{c}. The cut-off wavelength λ_{c} is reported herein as a cable cut-off wavelength. The cable cut-off wavelength is based on a 22-meter cabled fiber length. The 22-meter cable cut-off wavelength is typically less than the 2-meter cut-off wavelength due to higher levels of bending and mechanical pressure in the cable environment. The cable cut-off wavelength λ_{c} is equal to or below 1310 nm or equal to or below 1260 nm, and further in an example is in the wavelength range from 1160 nm to 1260 nm or in the range from 1160 nm to 1310 nm. Wavelengths at or above the cut-off wavelength λ_{c} reside in what is referred to herein as the single mode wavelength range of operation of the optical fiber.

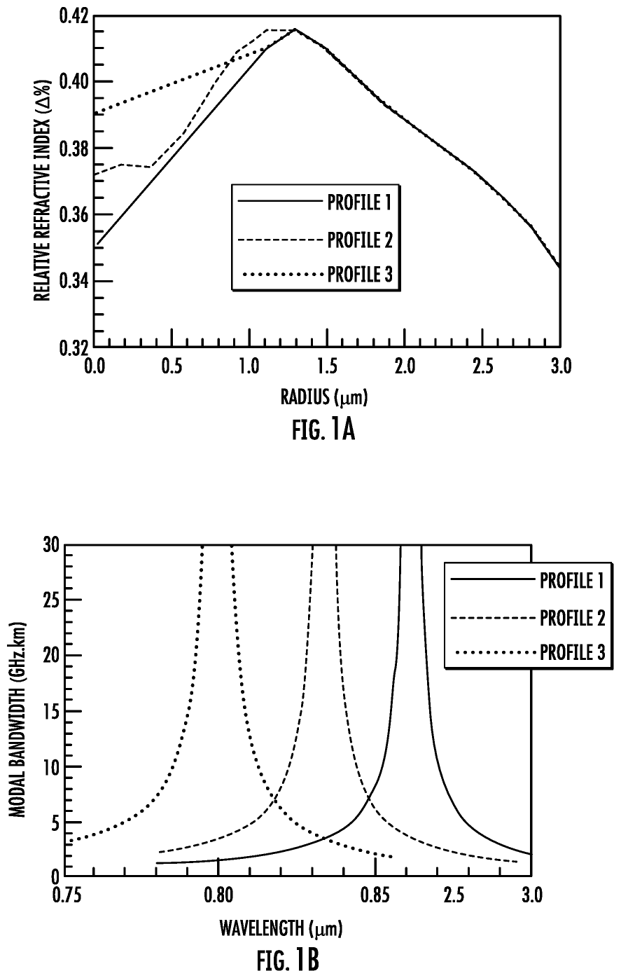

As shown in FIGS. 1A and 1B, the profile parameters of an optical fiber directly impact the wavelength at which a fiber reaches its peak modal bandwidth. For example, Profiles 1, 2, and 3 (as shown in FIG. 1A), each have a different relative refractive index profile. Furthermore, the peak modal bandwidth of Profile 1 (as shown in FIG. 1B) corresponds to a higher peak wavelength than Profile 2, and the peak modal bandwidth of Profile 2 corresponds to a higher peak wavelength than Profile 3. As is known in the art (and defined above), peak wavelength is defined as the wavelength at which the modal bandwidth reaches its maximum.

Embodiments of the present disclosure utilize the relationship between a fiber's profile parameters and the wavelength at which it reaches its peak modal bandwidth to categorize the fiber. Furthermore, embodiments of the present disclosure utilize the relationship between a fiber's peak modal bandwidth and the corresponding wavelength to categorize the fiber. More specifically, embodiments of the present disclosure categorize optical fibers based upon a calculated peak wavelength of the optical fibers. As discussed further below, the peak wavelength is calculated using profile parameters already obtained and/or calculated during the fiber production process. Thus, the embodiments disclosed herein do not require any additional data gathering steps. Additionally, the profile parameters may be obtained and/or calculated from a produced optical fiber or from an intermediate step in the fiber production process (such as, for example, a core cane). Based upon the calculated peak wavelength, the optical fibers may be categorized, for example, as those that are likely to meet a target modal bandwidth and those that are not at a wavelength of interest.

In some embodiments, the target modal bandwidth is a high modal bandwidth threshold. Thus, the fibers categorized as meeting the target modal bandwidth are classified as having a high modal bandwidth (or as a high probability of having the high modal bandwidth) at a wavelength of interest. Furthermore, the fibers categorized as not meeting the target modal bandwidth are classified as not having the high modal bandwidth (or a high probability of not having the high modal bandwidth) at the wavelength of interest. In some embodiments disclosed herein, the target modal bandwidth is 3 GHz·km at a wavelength of interest of 850 nm. Therefore, fibers classified as meeting the target modal bandwidth are classified as having a modal bandwidth of 3 GHz·km or higher (or a high probability of having such a modal bandwidth) at 850 nm. In other embodiments disclosed herein, the target modal bandwidth may be about 1 GHz·km or higher, or about 5 GHz·km or higher, or about 7 GHz·km or higher, or about 10 GHz·km or higher, or about 12 GHz·km or higher, or about 14 GHz·km or higher, or about 16 GHz·km or higher, or about 20 GHz·km or higher, or about 25 GHz·km or higher, or about 30 GHz·km or higher, or about 35 GHz·km or higher, or about 40 GHz·km or higher, or about 50 GHz·km or higher at the wavelength of interest. It is noted that the wavelength of interest may be based upon the particular system and VCSEL which the optical fiber is used with. For example, the wavelength of interest may be based upon a transmission distance needed at a particular data rate.

The single mode optical fibers disclosed herein may be single mode at an operating wavelength λ of about 1310 nm. In other embodiments, the operating wavelength λ is about 980 nm, or about 1060 nm, or about 1260 nm or greater, or greater than 1260 nm, or in the range of about 850 nm to about 950. In some embodiments, the single mode fibers are graded-index fibers. In other embodiments, the single mode fibers are step-index fibers. Single mode fibers, as disclosed herein, meet the requirements of the cutoff wavelength λ_{c} and the mode field diameter of standard single mode fibers while having optimal bandwidth for single mode or few mode VCSEL transmission in a wavelength range between 850 nm and 1060 nm. In the embodiments disclosed herein, the single mode fibers may be single-core or multicore embodiments. Furthermore, the single mode fibers disclosed herein may have dual use, namely they operate as a true single mode fiber (i.e., like a standard single fiber) at wavelengths above 1260 nm while operating as a few mode fiber at one or more wavelengths in the range of 850 nm to 1100 nm and with a high modal bandwidth. The single-core and multicore single mode fibers disclosed herein enable a cost effective and power efficient transmission for short reach optical fiber links.

The single mode fibers disclosed herein may be existing standard single mode fibers used for single-mode transmission. The single mode fibers disclosed herein can be made using standard optical fiber drawing techniques. In some embodiments, the fibers have optical properties that meet the G.652 industry standard, as is known in the art.

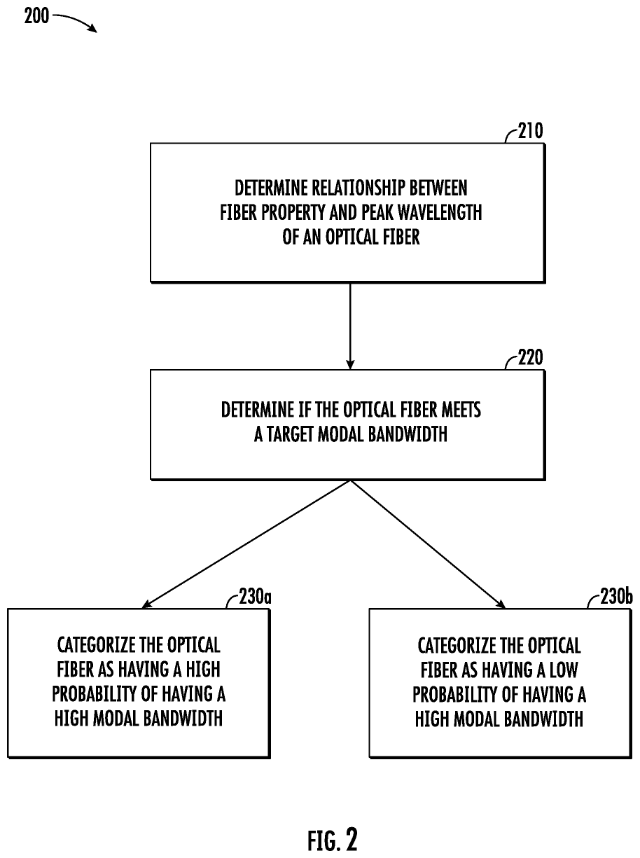

As shown in FIG. 2, a process 200 for categorizing single mode optical fibers is disclosed. Step 210 of process 200 comprises determining a relationship between a fiber property of a single mode optical fiber and peak wavelength of the optical fiber. In some embodiments, step 210 may comprise determining a relationship between a fiber property of a precursor to a single mode optical fiber and the peak wavelength of the optical fiber drawn from the precursor. The peak wavelength may be the peak bandwidth wavelength, as discussed above. The fiber property may be one property or a plurality of properties and may be related to the profile parameters of a fiber. As discussed above, the fiber properties may be factors that are already obtained and/or calculated during the production of the optical fiber. In some embodiments (and as discussed further below), the fiber property comprises at least one of (i) radius A of a centerline dip, (ii) depth B of a centerline dip, (iii) alpha value, (iv) core radius, (v) mode field diameter at 1310 nm, and (vi) zero dispersion wavelength. The inventors of the present disclosure discovered how each of these properties impacts the peak wavelength of the optical fiber and, thus, affects the corresponding modal bandwidth. Based upon these relationships, process 200 further comprises determining if the fiber meets a target modal bandwidth (step 220). In some embodiments, step 220 is performed by comparing the peak bandwidth wavelength of a fiber with a target peak wavelength λ_{T}. For example, if the peak wavelength of the fiber is equal to or greater than a first target peak wavelength λ_{T1} or less than or equal to a second target peak wavelength λ_{T2}, the optical fiber may be categorized as meeting the target modal bandwidth and, thus, as having a high probability of having a high modal bandwidth (step 230a). In these embodiments, if the peak wavelength of the fiber is less than the first target peak wavelength λ_{T1}, the fiber may be categorized as having a low probability of having a high modal bandwidth (step 230b). Furthermore, if the peak wavelength of the fiber is greater than the second target peak wavelength λ_{T2}, the fiber may be categorized as having a low probability of having a high modal bandwidth (step 230b). It is noted that in these embodiments, only the first target peak wavelength λ_{T1} or the second target peak wavelength λT2 may be used to categorize the fiber.

In other embodiments, the optical fiber may be categorized as meeting the target modal bandwidth and, thus, as having a high probability of having a high modal bandwidth (step 230a) if the peak wavelength of the fiber is equal to or greater than the first target peak wavelength λ_{T1} and less than or equal to the second target peak wavelength λ_{T2}. In these embodiments, if the peak wavelength is less than the first target peak wavelength λ_{T1} or greater than the second target peak wavelength λ_{T2}, the optical fiber may be categorized as not meeting the target modal bandwidth and, thus, as having a low probability of having a high modal bandwidth (step 230b). It is noted that in these embodiments, both the first target peak wavelength λ_{T1} and the second target peak wavelength λ_{T2} are used to categorize the fiber.

In other embodiments, step 220 is performed by comparing one or more of the fiber properties (i) through (vii) with a predetermined threshold.

The target peak wavelengths λ_{T1} and λ_{T2} may be determined based upon the operating conditions of the system in which the fiber is employed. For example, the target peak wavelengths λ_{T1} and λ_{T2} may be determined based upon the operating wavelength of the VCSELs or relevant laser source in a hyperscale data center. The operating wavelength may be between the first target peak wavelength λ_{T1} and the second target peak wavelength λ_{T2}. Furthermore, the first target peak wavelength λ_{T1} may be set to be less than the second target peak wavelength λ_{T2}. In some embodiments, the first target peak wavelength λ_{T1} is in a range from about 800 nm to about 900 nm, or about 815 nm to about 885 nm, or about 825 nm to about 875 nm, or about 835 nm to about 865 nm, or about 840 nm to about 860 nm. For example, the first target peak wavelength λ_{T1} may be about 800 nm, or about 815 nm, or about 825 nm, or about 835 nm, or about 845 nm, or about 850 nm, or about 865 nm, or about 875 nm. Furthermore, in some embodiments, the second target peak wavelength λ_{T2} is in a range from about 800 nm to about 960 nm, or about 820 nm to about 910 nm, or about 835 nm to about 885 nm, or about 850 nm to about 875 nm, or about 860 nm to about 870 nm. For example, the second target peak wavelength λ_{T2} may be about 850 nm, or about 865 nm, or about 875 nm, or about 885 nm, or about 895 nm, or about 900 nm, or about 910 nm, or about 925 nm.

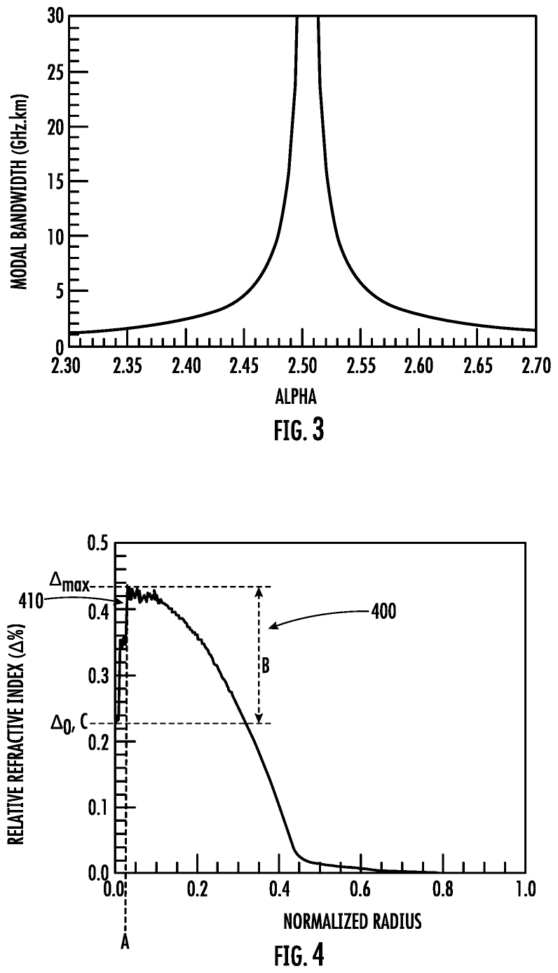

With reference again to step 210 of process 200, the inventors discovered the unique relationships between one or more fiber properties and the peak wavelength of an optical fiber and how those relationships relate to the peak modal bandwidth of the fiber. For example, an ideal graded-index single mode fiber has an alpha value of about 2.5 at the peak modal bandwidth and at a wavelength of 850 nm. FIG. 3 shows this relationship between modal bandwidth and alpha value for an ideal graded-index single mode optical fiber at a wavelength of 850 nm. However, many manufactured optical fibers comprise a centerline dip in a central portion of the core. The inventors of the present disclosure discovered that the size of the centerline dip (a property of the fiber) affects the alpha value of an optical fiber, which in turn correlates to a shift in peak modal bandwidth.

The centerline dip is intrinsic to the manufacturing process of an optical fiber. The size of the centerline dip in the core region can vary from one preform to another but remains substantially unchanged for a majority of each fiber's length (for example, the depth and width remain unchanged for about 50 km along the length of a fiber). When a fiber comprises a centerline dip, the inventors of the present disclosure discovered that the alpha value corresponding to the peak modal bandwidth at a wavelength of 850 nm is reduced. As discussed above with reference to FIG. 3, an ideal graded-index single mode fiber has an alpha value of about 2.5 at the peak modal bandwidth and at a wavelength of 850 nm. However, when a graded-index single mode optical fiber comprises a centerline dip, the alpha value corresponding to the peak modal bandwidth at a wavelength of 850 nm is reduced. Specifically, the alpha value is reduced from 2.5 to about 2.2. Therefore, the inclusion of the centerline dip in an optical fiber becomes a factor that can affect the peak modal bandwidth of a fiber. Accordingly, the inventors of the present disclosure studied the size of centerline dips in optical fibers (and in optical fiber precursors) to determine how they affect peak modal bandwidth.

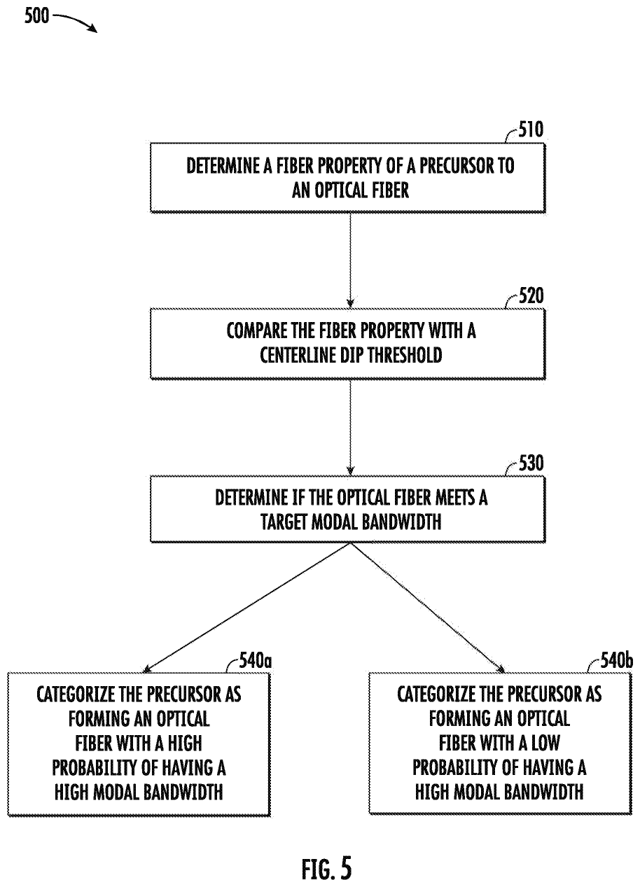

FIG. 4 depicts a plot of relative refractive index vs. normalized radius for an exemplary precursor fiber 400 (a core cane) corresponding to a graded-index single mode optical fiber. The radius of FIG. 4 is normalized to the maximum radius of the core cane (=R/Rₘₐₓ). The refractive index profile of precursor fiber 400 includes a centerline dip 410 with a radius A, a refractive index depth B, and a minimum refractive index value C. Centerline dip 410, as is known in the art, forms a lower index region at or near the centerline of the fiber. Therefore, the relative refractive index at the centerline (Δ₀) is less than the maximum relative refractive index (Δₘₐₓ) of the core. Due to the centerline dip, the maximum relative refractive index Δₘₐₓ of the core (and the maximum refractive index of the entire optical fiber) is located a distance away from the centerline of the core rather than at the centerline of the core. The radius A is the length of the dip from a radial center position of the core (i.e., the distance from the radial center position of the core to the maximum relative refractive index Δₘₐₓ). In some embodiments, the radius A is 3% of the cane core radius. The exemplary precursor fiber 400, as shown in FIG. 4, has a centerline dip radius A of 0.6 mm for a 20 mm cane core radius. The depth B of the centerline dip is the difference in refractive index from the maximum relative refractive index Δₘₐₓ of the core to the relative refractive index Δ₀. The exemplary precursor fiber 400, as shown in FIG. 4, has a centerline dip depth B of 0.21%. The minimum value C of the centerline dip is the relative refractive index Δ₀ at the centerline of the optical fiber. The exemplary precursor fiber 400, as shown in FIG. 4, has a minimum value C of 0.22%.

The radius A, the refractive index depth B, and the minimum refractive index value C all determine the size of the centerline dip in an optical fiber produced from the precursor fiber. Although a drawn optical fiber with a centerline dip would also have the same features of radius A, depth B, and minimum value C, it is noted that the values of A, B, and C are different from the precursor to that of the drawn fiber. For example, the centerline dip radius A of precursor fiber 400 may be greater than the centerline dip radius in the fiber drawn from precursor 400. Furthermore, the depth B of the centerline dip of precursor fiber 400 may be different from the depth of the centerline dip in the fiber drawn from precursor 400.

The inventors of the present disclosure discovered that the size of the centerline dip can determine whether a specific fiber has a high likelihood of meeting a target modal bandwidth at a wavelength of interest. Specifically, the inventors of the present disclosure discovered that a larger depth B of a centerline dip corresponds to a higher peak bandwidth wavelength. Furthermore, the inventors of the present disclosure discovered that a smaller minimum value C corresponds to a higher peak bandwidth wavelength. For example, with reference to FIG. 1A, Profile 1 has a larger depth B and a smaller minimum value C with regard to its centerline dip than either Profile 2 or Profile 3. Furthermore, with reference to FIG. 1B, Profile 1 has higher wavelength corresponding to the peak modal bandwidth than either Profile 2 or Profile 3. Although not depicted with Profiles 1, 2, and 3, the inventors additionally discovered that a larger radius A corresponds to a higher peak bandwidth wavelength.

FIG. 5 depicts a process 500 of categorizing single mode optical fibers based upon the above-disclosed relationship between the centerline dip of a precursor to an optical fiber and the peak modal bandwidth of the fiber. Step 510 of process 500 comprises determining a fiber property of a precursor to an optical fiber. The precursor to the optical fiber may be the core cane or the overclad blank of the optical fiber before it is drawn. In some embodiments, the fiber is a single mode optical fiber at an operating wavelength of about 1310 nm and

wherein a core portion of the precursor and of the drawn optical fiber includes a centerline dip. Furthermore, in some embodiments, the fiber property is the depth B of the centerline dip of the precursor to the optical fiber. Step 520 of process 500 comprises comparing the fiber property with a centerline dip threshold (CD_{T}). Thus, step 520 comprises determining if the fiber property is above, below, or equal to the centerline dip threshold CD_{T}. Step 530 of process 500 comprises determining if the optical fiber (once drawn) would meet a target modal bandwidth. The determination of step 530 may be based upon the comparison of step 520. For example, it may be determined that the drawn optical fiber would meet the target modal bandwidth if the fiber property (e.g., the depth B of the centerline dip) is equal to or greater than the centerline dip threshold (B≥CD_{T}). Precursors determined to meet the target modal bandwidth may be classified as forming fibers with a high probability of having a high modal bandwidth (step 540a). Precursors determined to not meet the target modal bandwidth may be classified as forming fibers with a low probability of having a high modal bandwidth (step 540b).

In one example of process 500, the centerline dip threshold CD_{T} is 0.2% and the target modal bandwidth is 6 GHz·km at the wavelength of interest of 850 nm. Therefore, precursor fibers having a depth B of the centerline dip of equal to or greater than 0.2% will meet the target modal bandwidth and will be classified as having a high probability of forming fibers with a high modal bandwidth (i.e., fibers with a peak modal bandwidth of 6 GHz·km or greater at 850 nm). Precursor fibers having a depth B of the centerline dip less than 0.2% will not meet the target modal bandwidth and will be classified as having a low probability of forming fibers with a high modal bandwidth. As shown in FIG. 4, as one exemplary example, precursor fiber 400 has depth B of the centerline dip of 0.21%, which is greater than the centerline dip threshold CD_{T} of 0.2%. Therefore, precursor fiber 400, in this example, would be classified as having a high probability of forming a fiber with a high modal bandwidth.

It is also noted that Profiles 1, 2, and 3 of FIG. 1A all have a depth B of less than 0.2%. However, the Profiles 1, 2, and 3 of FIG. 1A are for drawn optical fibers. Process 500 of FIG. 5 is for a precursor fiber (before the drawing step). Therefore, process 500 does not apply to the Profiles 1, 2, and 3 of FIG. 1A.

Table 1 below confirms the relationship between the precursor fiber property of value B and peak modal bandwidth of a drawn fiber. As shown in Table 1, five different precursor fibers of graded-index single mode fibers, each with a depth B of the centerline dip of 0.2% or greater, were selected from a group of precursor fibers. The peak modal bandwidth and corresponding wavelength were then measured for the fibers drawn from each of these five precursor fibers. Three out of the five fibers (Fibers 2, 3, and 5) each have a peak modal bandwidth meeting the target modal bandwidth of 6 GHz·km or greater at 850 nm. It is noted that the target modal bandwidth of 6 GHz·km was used in this example because it generally corresponds to high data rate transmission and a peak bandwidth wavelength of about 850 nm (±20 nm).

TABLE 1

| | Peak Modal Bandwidth at | Peak Bandwidth |
|---|---|---|
| Fiber | 850 nm (GHz · km) | Wavelength (nm) |
| 1 | 1.63 | 794 |
| 2 | 13.4 | 856 |
| 3 | 6.11 | 835 |
| 4 | 1.22 | 745 |
| 5 | 6.78 | 870 |

Thus, as verified by Table 1 above, process 500 provides a 60% rate of accurately selecting fibers with a high modal bandwidth. As also shown in Table 1, Fibers 2, 3, and 5 have a peak bandwidth wavelength of approximately 850 nm (e.g., within the range of 825 nm to 875 nm). As discussed further below, the inventors discovered that the peak bandwidth wavelength of a fiber is also another factor one can use to determine the probability of a fiber having a high modal bandwidth.

As discussed above, the radius A, the depth B, and the minimum refractive index value C can be obtained and/or calculated from a precursor fiber and, thus, before a fiber preform is drawn into the final optical fiber. These values allow one to categorize the precursor as having either a low or high probability of forming a fiber with a high modal bandwidth before the precursor is drawn into the final product. Therefore, by using the processes disclosed herein, one can categorize the precursors before they are drawn so that only the precursors with a high probability are drawn into the final product. Such can save time and resources.

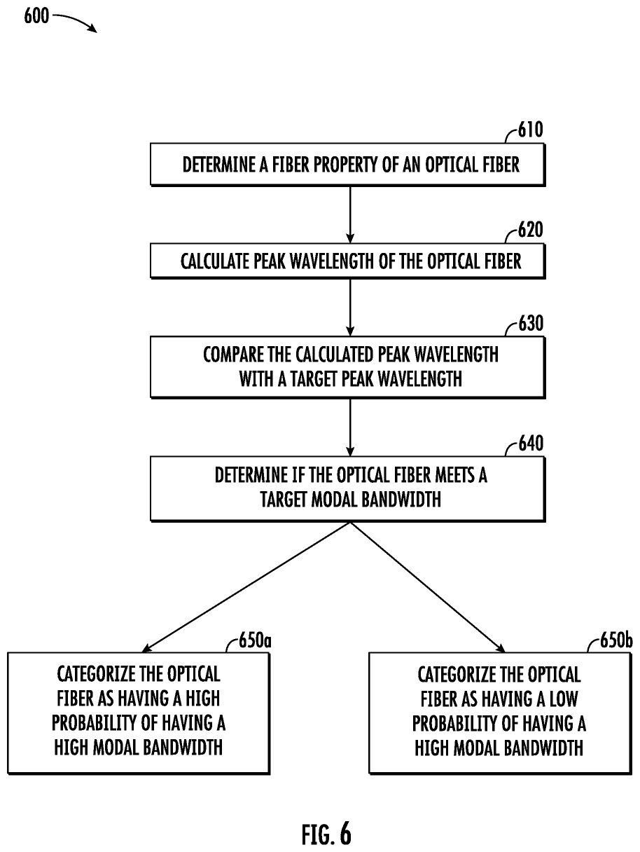

Process 600, as shown in FIG. 6, depicts another embodiment of categorizing single mode optical fibers based upon the above-disclosed relationship between one or more fiber properties of a fiber and peak modal bandwidth. In comparison to process 500, the steps of process 600 are after the drawing of the optical fiber. Step 610 of process 600 comprises determining a fiber property of an optical fiber. In some embodiments, the fiber is a single mode optical fiber at an operating wavelength of about 1310 nm. Furthermore, in some embodiments, the fiber property is at least one of (i) radius A of a centerline dip, (ii) depth B of the centerline dip, (iii) alpha value, (iv) core radius, (v) mode field diameter at 1310 nm, and (vi) zero dispersion wavelength. Step 620 of process 600 comprises calculating a peak wavelength λₚ of the optical fiber using the one or more fiber properties. The calculated peak wavelength λₚ is the wavelength corresponding to the peak modal bandwidth of a fiber and is calculated using the different embodiments disclosed herein (as discussed further below). The inventors of the present disclosure discovered the unique relationship between the fiber properties (i) through (vi) listed above and peak wavelength of a fiber. Discussed further below are two exemplary embodiments to calculate the peak wavelength λₚ using one or more fiber properties (i) through (vi).

Referring further to FIG. 6, step 630 of process 600 comprises comparing the calculated peak wavelength λₚ with a target peak wavelength Thus, step 630 comprises determining if the calculated peak wavelength λₚ is above, below, or equal to the target peak wavelength λ_{T}. The target peak wavelength λ_{T} is the wavelength corresponding to a target peak modal bandwidth of a fiber. For example, in some embodiments, the target peak modal bandwidth and target peak wavelength λ_{T} may be 6 GHz·km and 850 nm, respectively.

In some embodiments, step 630 of process 600 comprises comparing the calculated peak wavelength λₚ with a first target peak wavelength λ_{T1} and a second target peak wavelength λ_{T2}. This comparison step may further comprise determining if the calculated peak wavelength λₚ is equal to or greater than the first target peak wavelength λ_{T1} and less than or equal to the second target peak wavelength λ_{T2}. As one exemplary embodiment, the first target peak wavelength λ_{T1} is 825 nm and the second target peak wavelength λ_{T2} is 875 nm. Therefore, in this exemplary embodiment, step 630 comprises determining if the calculated peak wavelength λₚ is within the range of 825 nm to 875 nm.

Step 640 of process 600 comprises determining if the optical fiber meets a target modal bandwidth at a wavelength of interest. The determination of step 640 may be based upon the comparison of step 630. For example, it may be determined that the optical fiber meets the target modal bandwidth if the calculated peak wavelength is equal to or greater than the target peak wavelength (λₚ≥λ_{T}) or within the range of the first and second target peak wavelengths (λ_{T1}≤λₚ≤λ_{T2}). Fibers that meet the target modal bandwidth may then be classified as fibers with a high probability of having a high modal bandwidth (step 650a). Fibers that do not meet the target modal bandwidth may be classified as fibers with a low probability of having a high modal bandwidth (step 650b).

As discussed above, the calculated peak wavelength λₚ may be calculated (step 620 of process 600) using the different embodiments disclosed herein. In a first exemplary embodiment, the calculated peak wavelength λₚ in step 620 is calculated using (i) radius of A of a centerline dip, (ii) depth B of the centerline dip, (iii) alpha value, and (iv) core radius. For this first exemplary embodiment, the alpha value is extracted using the delta profile in a region from 1.1 microns to 5.7 microns.

In some applications of the first exemplary embodiment, the calculated peak wavelength λₚ is determined using equation (1) below:

λₚ=−301.356+(1480.371×B)+(87.181×A)+(317.456×α)+(49.293×R) (1)

wherein λₚ is the calculated peak wavelength, B is the depth of a centerline dip in a drawn optical fiber, A is the radius of the centerline dip in a drawn optical fiber, α is the alpha, and R is the core radius. As discussed above, the depth B of the centerline dip is calculated using the maximum relative refractive index Δₘₐₓ and the relative refractive index Δ₀ so that the calculated peak wavelength λₚ is determined based upon the Δₘₐₓ and Δ₀.

Equation (1) was derived using relationships between the fiber properties and peak wavelength of Fibers A1 through A10 shown in Table 2 below.

TABLE 2

| | | | | | | | Absolute |
|---|---|---|---|---|---|---|---|
| | | | | | | | Difference |
| | | | | | | | Between |
| | | Radius of | | | Calculated | Measured | Calculated and |
| | | A of | | | Peak | Peak | Measured Peak |
| | Depth B of | Centerline | | | Bandwidth | Bandwidth | Bandwidth |
| | Centerline | Dip | Alpha | Core Radius | Wavelength | Wavelength | Wavelength |
| Fiber | Dip (%) | (microns) | Value | (microns) | (nm) | (nm) | (nm) |
| A1 | 0.040 | 1.295 | 1.968 | 6.140 | 798.56 | 795.93 | 2.63 |
| A2 | 0.045 | 1.110 | 2.047 | 6.058 | 809.93 | 808.73 | 1.20 |
| A3 | 0.045 | 1.295 | 2.121 | 6.227 | 858.38 | 878.84 | 20.46 |
| A4 | 0.028 | 1.110 | 2.476 | 6.075 | 922.53 | 926.27 | 3.74 |
| A5 | 0.034 | 1.295 | 2.081 | 6.284 | 832.90 | 827.06 | 5.84 |
| A6 | 0.033 | 1.295 | 2.186 | 6.272 | 864.27 | 865.45 | 1.18 |
| A7 | 0.030 | 1.295 | 2.100 | 6.413 | 838.09 | 841.83 | 3.74 |
| A8 | 0.033 | 1.295 | 2.424 | 6.266 | 939.06 | 931.94 | 7.12 |
| A9 | 0.050 | 1.295 | 2.136 | 6.209 | 870.36 | 860.61 | 9.75 |
| A10 | 0.033 | 1.110 | 2.021 | 6.297 | 796.77 | 794.25 | 2.52 |

Equation (1) above was obtained using linear regression analysis for the fiber properties and the measured peak bandwidth wavelength data shown in Table 2 above. Using the discovered relationships between the fiber properties and peak bandwidth wavelength, one can accurately estimate the peak bandwidth wavelength for a given fiber using equation (1). Thus, the calculated peak bandwidth wavelengths in Table 2 were calculated using equation (1). However, it is noted that equation (1) is based upon the fiber property data extrapolated from the fibers of Table 2 above. Therefore, equation (1) may change if using a different set of fibers to extrapolate the fiber properties.

The inventors of the present disclosure further tested the accuracy of equation (1) to calculate peak bandwidth wavelength, the results of which are shown in Table 3 below. In Table 3, the calculated peak bandwidth wavelength was calculated for each fiber using equation (1) such that the calculated peak bandwidth wavelength corresponds to the calculated peak wavelength λₚ discussed above.

TABLE 3

| | | | | | | | Absolute |
|---|---|---|---|---|---|---|---|
| | | | | | | | Difference |
| | | Radius of | | | Calculated | Measured | Between |
| | Depth B | A of | | | Peak | Peak | Calculated and |
| | of | Centerline | | Core | Bandwidth | Bandwidth | Measured Peak |
| | Centerline | Dip | Alpha | Radius | Wavelength | Wavelength | Bandwidth |
| Fiber | Dip (%) | (microns) | Value | (microns) | (nm) | (nm) | Wavelength (nm) |
| B1 | 0.035 | 1.295 | 2.052 | 6.372 | 828.68 | 775.88 | 52.80 |
| B2 | 0.051 | 1.295 | 2.051 | 6.378 | 852.80 | 863.42 | 10.62 |
| B3 | 0.043 | 1.295 | 2.122 | 6.404 | 864.82 | 884.60 | 19.78 |
| B4 | 0.043 | 1.110 | 2.123 | 6.332 | 845.23 | 842.95 | 2.28 |
| B5 | 0.052 | 1.295 | 2.063 | 6.262 | 851.97 | 861.87 | 9.90 |
| B6 | 0.022 | 1.110 | 2.530 | 6.100 | 931.62 | 914.16 | 17.46 |
| B7 | 0.049 | 1.110 | 2.036 | 6.126 | 815.51 | 751.07 | 64.44 |
| B8 | 0.034 | 1.295 | 2.003 | 6.122 | 799.61 | 794.16 | 5.45 |
| B9 | 0.031 | 1.295 | 2.140 | 6.413 | 852.46 | 897.67 | 45.21 |
| B10 | 0.039 | 1.295 | 2.020 | 6.145 | 813.60 | 797.44 | 16.16 |
| B11 | 0.042 | 1.295 | 2.007 | 5.932 | 802.52 | 794 | 8.52 |
| B12 | 0.047 | 1.480 | 2.042 | 6.250 | 853.28 | 856 | 2.72 |
| B13 | 0.044 | 1.110 | 2.039 | 5.940 | 800.94 | 835 | 34.06 |
| B14 | 0.032 | 1.110 | 2.007 | 6.130 | 781.49 | 745 | 36.49 |
| B15 | 0.062 | 1.110 | 2.100 | 6.440 | 871.15 | 870 | 1.15 |
| B16 | 0.043 | 1.295 | 2.211 | 6.292 | 887.65 | 851 | 36.65 |
| B17 | 0.033 | 1.110 | 2.141 | 6.348 | 836.70 | 843 | 6.30 |
| B18 | 0.027 | 1.295 | 1.890 | 5.930 | 743.03 | 748 | 4.97 |
| B19 | 0.033 | 1.295 | 2.034 | 5.990 | 801.79 | 771 | 30.79 |
| B20 | 0.034 | 1.295 | 2.043 | 6.017 | 807.40 | 796 | 11.40 |
| B21 | 0.035 | 1.295 | 2.067 | 6.037 | 816.93 | 813 | 3.93 |

As shown in Table 3, the calculated peak bandwidth wavelength for each fiber B1 through B21 was compared with a measured peak bandwidth wavelength. Fourteen out of the twenty-one fibers provided an accurate determination of the calculated peak bandwidth wavelength with a difference between the calculated and measured wavelengths being 20 nm or less. Of the twenty-one tested fibers in Table 3, only fibers B1, B7, B9, B13, B14, B16, B19 did not have a difference between the calculated and measured wavelengths of 20 nm or less. Thus, the results of Table 3 show that the wavelength calculation of equation (1) provides a 67% accuracy rate to calculate the peak wavelength λₚ and, thus, to estimate the peak modal bandwidth of the fiber based upon the calculated peak wavelength λₚ.

Furthermore, Tables 2 and 3 above provide exemplary examples of using equation (1) to categorize an optical fiber using process 600. For example, Fiber B12 in Table 1 has a calculated peak wavelength λₚ of 853.28 nm, such that the calculated peak wavelength λₚ was calculated using properties (i) through (iv) above and equation (1). Thus, with reference to FIG. 6, step 620 of process 600 was performed by calculating the peak wavelength λₚ using equation (1). Next, in step 630, the calculated peak wavelength λₚ of 853.28 nm was compared with a target peak wavelength, which in this example, comprises a first target peak wavelength λ_{T1} of 825 nm and a second target peak wavelength λ_{T2} of 875 nm, which are chosen to accommodate the transceiver wavelength. Because the calculated peak wavelength λₚ is less than the second target peak wavelength λ_{T2} and greater than the first target peak wavelength λ_{T1}(λ_{T1}≤λₚ≤λ_{T2}), it would be determined in step 640 that the optical fiber meets the target modal bandwidth. Thus, as shown in step 650a, the fiber would be categorized as having a high probability of having a high modal bandwidth.

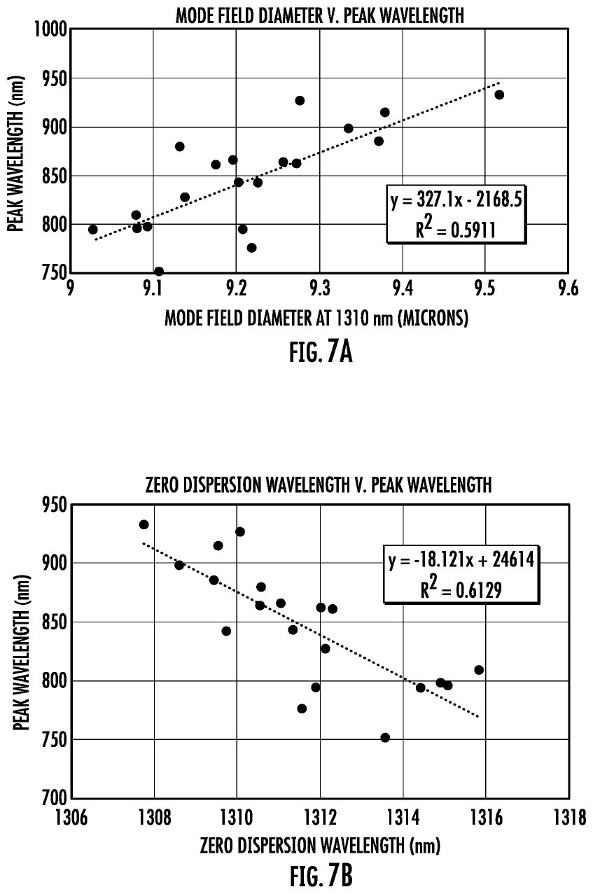

In a second exemplary embodiment, the calculated peak wavelength λₚ in step 620 of process 600 is calculated using (v) mode field diameter at 1310 nm and (vi) zero dispersion wavelength. The inventors of the present disclosure discovered how these fiber properties are related to peak bandwidth wavelength in order to calculate the wavelength (to in turn categorize the fibers as meeting or not meeting the target modal bandwidth). For example, FIG. 7A shows how mode field diameter at 1310 nm is related to peak bandwidth wavelength for twenty graded-index single mode drawn optical fibers. As shown in FIG. 7A, a higher mode field diameter generally corresponds to a higher peak wavelength. FIG. 7B shows how zero dispersion wavelength is related to peak bandwidth wavelength for the same twenty fibers. As shown in FIG. 7B, a higher zero dispersion wavelength generally corresponds to a lower peak wavelength. It is noted that the peak bandwidth wavelengths in FIGS. 7A and 7B are measured rather than calculated.

The inventors of the present disclosure further discovered that the relationships of mode field diameter and zero dispersion wavelength with peak bandwidth wavelength can be combined to accurately calculate the peak bandwidth wavelength of an optical fiber. Thus, in some applications of the second exemplary embodiment, the calculated peak wavelength λₚ is determined using equation (2) below:

λₚ=(50.79×MFD)−(15.24×λ₀)+20369.23 (2)

wherein λₚ is the calculated peak wavelength, MFD is the mode field diameter at 1310 nm, and λ₀ is the zero dispersion wavelength.

Equation (2) above was extrapolated using the data of Table 4 below for twenty-five optical fibers.

TABLE 4

| | | | Measured Peak |
|---|---|---|---|
| | Mode Field | | Bandwidth |
| | Diameter at | Zero Dispersion | Wavelength |
| Fiber | 1310 nm (microns) | Wavelength (nm) | (nm) |
| C1 | 8.99 | 1315.1 | 795 |
| C2 | 9.10 | 1313.6 | 751 |
| C3 | 9.07 | 1315.8 | 808 |
| C4 | 9.10 | 1310.6 | 878 |
| C5 | 9.12 | 1312.1 | 827 |
| C6 | 9.19 | 1311.1 | 865 |
| C7 | 9.23 | 1309.8 | 841 |
| C8 | 9.34 | 1308.6 | 897 |
| C9 | 9.50 | 1307.8 | 931 |
| C10 | 9.07 | 1314.9 | 797 |
| C11 | 9.17 | 1312.3 | 860 |
| C12 | 9.19 | 1311.9 | 794 |
| C13 | 9.23 | 1311.6 | 775 |
| C14 | 9.27 | 1310.6 | 863 |
| C15 | 9.38 | 1309.5 | 884 |
| C16 | 9.19 | 1311.4 | 842 |
| C17 | 9.24 | 1312.1 | 861 |
| C18 | 9.34 | 1309.6 | 914 |
| C19 | 9.30 | 1310.1 | 926 |
| C20 | 9.01 | 1314.4 | 794 |
| C21 | 8.95 | 1317.7 | 794 |
| C22 | 9.23 | 1312.3 | 856 |
| C23 | 9.23 | 1311.6 | 835 |
| C24 | 9.078 | 1314.8 | 745 |
| C25 | 9.18 | 1312.0 | 870 |

As discussed above, the target peak wavelength λ_{T} may be a wavelength range (such as the first and second target peak wavelengths). Equation (2) is obtained by fitting a data set to the target peak wavelength range. By using a wavelength range, rather than one specific target value, one can maximize the rate of fibers meeting the target peak wavelength λ_{T} without needing to know their precise bandwidth value.

The inventors of the present disclosure further discovered that, in general, for single mode optical fibers with a peak bandwidth wavelength of about 850 nm (specifically within the range of 825 nm to 875 nm), the mode field diameter at 1310 nm is within the range of about 9.1 microns to about 9.3 microns and that the zero dispersion wavelength is within the range of about 1309 nm to about 1313 nm. As shown in Table 4, the following thirteen fibers all meet these criteria for both mode field diameter and zero dispersion wavelength: fibers C5-C7, C11-C14, C16, C17, C19, C22, C23, and C25. Of these fibers, only C12, C13, and C19 do not have a calculated peak bandwidth wavelength within the desired range of 825 nm to 875 nm. Thus, when using the mode field and zero dispersion wavelength criteria, ten out of thirteen fibers accurately predicted the peak bandwidth wavelength of the optical fiber. Thus, in some embodiments, one can determine that an optical fiber meets the target modal bandwidth by selecting a fiber with the following properties: mode field diameter at 1310 nm is within the range of about 9.1 microns to about 9.3 microns and zero dispersion wavelength is within the range of about 1309 nm to about 1313 nm.

Furthermore, Table 4 above provides exemplary examples using equation (2) to categorize an optical fiber using process 600. For example, Fiber C22 in Table 4 has a calculated peak wavelength λₚ of 856 nm, such that the calculated peak wavelength λₚ was calculated using properties (v) and (vi) above and equation (2). Thus, with reference to FIG. 6, step 620 of process 600 was performed by calculating the peak wavelength λₚ using equation (2). It is noted that in this example, the calculated peak wavelength λₚ is the same as the measured peak bandwidth wavelength shown in Table 4. Next, in step 630, the calculated peak wavelength λₚ of 856 nm was compared with a first target peak wavelength λ_{T1} and with a second target peak wavelength λ_{T2}. In some one embodiments, the first target peak wavelength λ_{T1} is 825 nm and the second target peak wavelength λ_{T2} is 875 nm, which is based upon the transceiver wavelength. Because the calculated peak wavelength λₚ is greater than the first target peak wavelength λ_{T1} and less than the second target peak wavelength λ_{T2} (λ_{T1}≤λₚ≤λ_{T2}), in step 640 it would be determined that the optical fiber meets the target modal bandwidth. Thus, as shown in step 650a, the fiber would be categorized as having a high probability of having a high modal bandwidth.

It is noted that equations (1) and (2) and processes 500 and 600 use fiber properties from a finalized fiber after it is drawn to determine whether a fiber has a high likelihood or not of having a high modal bandwidth. Therefore, the probability of a fiber being correctly categorized as having a high modal bandwidth or not is more accurate than when using fiber properties determined during an intermediate step of the fiber drawing process (such as, for example, a property determined from a core cane precursor).

The embodiments disclosed herein may accurately categorize an optical fiber without adding any additional data gathering steps to the fiber production process. Thus, the fiber may be categorized using data already determined and/or calculated during the production process of the optical fiber. The categorization of the optical fiber is based upon the unique relationships between one or more fiber properties and the peak wavelength of an optical fiber and how that relationship relates to the peak modal bandwidth of the fiber.

It will be apparent to those skilled in the art that various modifications and variations can be made without departing from the spirit or scope of the claims.

What is claimed is:

1. A method of categorizing single mode optical fibers, the method comprising:
determining one or more fiber properties of an optical fiber, the optical fiber being a single mode optical fiber at an operating wavelength of about 1310 nm;
calculating a peak bandwidth wavelength of the optical fiber based on the one or more fiber properties;
comparing the calculated peak bandwidth wavelength with a target peak bandwidth wavelength; and
based on the comparison, determining if the optical fiber meets a target modal bandwidth.

2. The method of claim 1, wherein the optical fiber is a graded-index single mode optical fiber.

3. The method of claim 1, further comprising calculating the peak bandwidth wavelength based upon a predetermined relationship between the fiber properties and the peak bandwidth wavelength.

4. The method of claim 3, wherein the fiber properties comprise at least one of (i) radius (A) of a centerline dip, (ii) depth B of the centerline dip, (iii) alpha value, (iv) core radius, (v) mode field diameter at 1310 nm, and (vi) zero dispersion wavelength.

5. The method of claim 4, wherein the fiber properties comprise (i) radius A of a centerline dip, (ii) depth B of the centerline dip, (iii) alpha value, and (iv) core radius.

6. The method of claim 5, wherein the calculated peak bandwidth wavelength of the optical is calculated using the following equation:
λₚ=−301.356+(1480.371×B)+(87.181×A)+(317.456×α)+(49.293×R),
wherein λₚ is the calculated peak bandwidth wavelength (nm), B is the depth of a centerline dip (%), A is the radius of the centerline dip (microns), α is the alpha, and R is the core radius (microns).

7. The method of claim 4, wherein the fiber properties comprise (v) mode field diameter at 1310 nm and (vi) zero dispersion wavelength.

8. The method of claim 7, wherein the calculated peak bandwidth wavelength of the optical is calculated using the following equation:
λₚ=(50.79×MFD)−(15.24×λ₀)+20369.23
wherein λₚ is the calculated peak bandwidth wavelength (nm), MFD is the mode field diameter at 1310 nm (microns), and λ₀ is the zero dispersion wavelength (nm).

9. The method of claim 1, wherein the mode field diameter at 1310 nm of the optical fiber is within a range of about 9.1 microns to about 9.3 microns and the zero dispersion wavelength of the optical fiber is within a range of about 1309 nm to about 1313 nm.

10. The method of claim 1, wherein the target peak bandwidth wavelength comprises a first target peak wavelength of 825 nm and a second target peak wavelength of 875 nm.

11. The method of claim 10, further comprising determining if the calculated peak bandwidth wavelength is equal to or greater than the first target peak wavelength and less than or equal to the second target peak wavelength.

12. The method of claim 1, wherein the target modal bandwidth is about 3 GHz·km or higher.

13. The method of claim 12, wherein the target modal bandwidth is about 7 GHz·km or higher.

14. The method of claim 1, further comprising categorizing the optical fiber as having a high probability of having a high modal bandwidth if it is determined the optical fiber meets the target modal bandwidth.

15. The method of claim 1, further comprising categorizing the optical fiber as having a low probability of having a high modal bandwidth if it is determined the optical fiber does not meet the target modal bandwidth.

16. A method of categorizing single mode optical fiber precursors, the method comprising:
determining a fiber property of an optical fiber precursor,
the optical fiber precursor being a precursor to a single mode optical fiber at an operating wavelength of about 1310 nm,
a core portion of the optical fiber precursor having a centerline dip, and
the fiber property being a depth of the centerline dip of the core portion;
comparing the fiber property with a centerline dip threshold; and
based on the comparison, determining if the optical fiber precursor has a high probability of forming an optical fiber with a high modal bandwidth.

17. The method of claim 16, further comprising determining that the optical fiber precursor has a high probability of forming an optical fiber with a high modal bandwidth if the depth of the centerline dip is equal to or greater than the centerline dip threshold.

18. The method of claim 16, wherein the depth of the centerline dip is determined from a refractive index profile plot of relative refractive index versus radius.

19. The method of claim 18, wherein the wherein the centerline dip threshold is 0.2%.

20. A method of categorizing single mode optical fibers, the method comprising:
determining a relationship between peak bandwidth wavelength in a drawn optical fiber and one or more fiber properties, the optical fiber being a single mode optical fiber at about 1310 nm,
the one or more fiber properties including at least one of: (i) radius A of a centerline dip in the optical fiber, (ii) depth B of the centerline dip in the optical fiber, (iii) depth B of the centerline dip in a precursor to the optical fiber, (iv) alpha value in the optical fiber, (v) core radius in the optical fiber, (vi) mode field diameter at 1310 nm in the optical fiber, and (vii) zero dispersion wavelength in the optical fiber; and
based on the relationship, determining if the optical fiber meets a target modal bandwidth.
